(19) United States
(12) Patent Application Publication
(10) Pub. No.: US 2012/0022798 A1
(43) Pub. Date: Jan. 26, 2012

(54) METHOD FOR PREDICTING IMPACT RESISTANCE OF ACRYLONITRILE BUTADIENE STYRENE (ABS) MATERIAL

(75) Inventors: Ju Hyung Lee, Seoul (KR); Min Chul Shin, Seoul (KR); Seok Jin Choi, Gyeonggi-do (KR); Chang Kook Hong, Gwangju (KR); Song Yi Bae, Gwangju (KR)

(73) Assignees: INDUSTRY FOUNDATION OF CHONNAM NATIONAL UNIVERSITY, Gwangju (KR); HYUNDAI MOTOR COMPANY, Seoul (KR)

(21) Appl. No.: 12/939,436

(22) Filed: Nov. 4, 2010

(30) Foreign Application Priority Data
Jul. 20, 2010 (KR) 10-2010-0070103

(51) Int. Cl. G06F 19/00; G01N 3/00

(52) U.S. Cl. 702/41

(57) ABSTRACT

The present invention provides a model equation for predicting the impact resistance of an ABS material, which has excellent properties, gloss, and stainability and thus can be widely used in vehicles, electricity and electronics, and miscellaneous applications. The model equation of the present invention provides high accuracy and reproducibility. The prediction technology can be used particularly to determine whether a material complies with the specification of vehicle components, to overcome the quality problems, and to prevent the production of defective products.

### CROSS-REFERENCE TO RELATED APPLICATION

This application claims under 35 U.S.C. §119(a) the benefit of Korean Patent Application No. 10-2010-0070103 filed Jul. 20, 2010, the entire contents of which are incorporated herein by reference.

### BACKGROUND

(a) Technical Field

The present disclosure relates to a method for predicting the impact resistance of an acrylonitrile butadiene styrene (ABS) material.

(b) Background Art

An acrylonitrile butadiene styrene (ABS) material comprises a styrene acrylonitrile (SAN) copolymer and a rubber phase (generally, SAN-grafted butadiene). The properties of the ABS material are influenced by the rubber phase contained therein. The ABS can be expressed by the following formula 1.

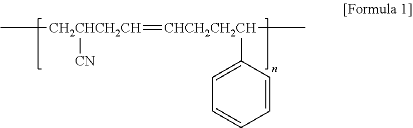

In general, the higher the rubber content, the higher the impact resistance. The impact resistance is also influenced by the interfacial tension between the rubber phase and the SAN matrix. In practice, the rubber content and viscosity are adjusted based on the properties required for each component. However, in the event of a quality problem such as damage, it is impossible to prepare a specimen in the component state, and thus it is impossible to predict with any accuracy the level of impact resistance. Therefore, there is a need in related industries for the development of a model equation that can predict impact resistance even in the event of a quality problem.

### SUMMARY OF THE DISCLOSURE

The present invention provides a method for predicting the impact resistance of acrylonitrile butadiene styrene (ABS) materials. In particular, the inventors of the present invention discovered that the impact resistance of an acrylonitrile butadiene styrene (ABS) material has a close relationship with the rubber phase content, surface tension, and viscosity. Accordingly, the present invention provides a simple and reliable test method for predicting the impact resistance of an ABS material by analyzing the properties of the ABS materials, particularly the rubber phase content, surface tension, and viscosity of the ABS material.

In particular, the inventors of the present invention discovered that the impact resistance of an ABS material is related to the viscosity, the surface tension, and the size of rubber phase. As a result, a simple and reliable test method has been developed for predicting the impact resistance of the ABS material by measuring the viscosity, the surface tension, and the size of rubber phase of a corresponding ABS material.

In one aspect, the present invention provides a method for predicting impact resistance of an acrylonitrile butadiene styrene (ABS) material (“the AMS material”). In accordance with this aspect, the method includes calculating a correlation between impact resistance, viscosity, interfacial tension, and size of rubber phase by measuring the impact resistance, the viscosity, the interfacial tension, and the size of the rubber phase of a standard ABS material (“standard AMS material”); measuring the viscosity, the interfacial tension, and the size of the rubber phase of the ABS material; and predicting the impact resistance by substituting the measured viscosity, interfacial tension, and size of the rubber phase of the AMS material into a correlation calculated from the standard ABS material.

It has been discovered that when the content of butadiene as a rubber phase in the ABS material is increased, the impact resistance is improved. However, when the rubber content continues to be increased excessively, the opposite occurs and the properties of the ABS material are deteriorated on further increase in rubber content. With respect to the interfacial tension value, a criterion of compatibility between the rubber phase and matrix, as this value becomes lower the affinity therebetween (i.e. between the rubber phase and SAN matrix) is increased. The interfacial tension value can be indirectly represented by the surface tension value when it is difficult to separate the two phases. The interfacial tension value is a very important factor that determines compatibility. It is expected that the surface properties will vary according to the rubber content even when using the indirect measurement of the surface tension. The collective behavior of these factors is defined as a viscosity value and particularly is measured as a melt viscosity value. The melt viscosity can be calculated by

$$\frac{\sqrt{( {G}^{′2} + {G}^{″2} )}}{Angular velocity}$$

using the sum of a storage modulus (G′) and a loss modulus (G″). Thus, the viscosity value can represent the impact resistance as the degree of elasticity.

It is understood that the term “vehicle” or “vehicular” or other similar term as used herein is inclusive of motor vehicles in general such as passenger automobiles including sports utility vehicles (SUV), buses, trucks, various commercial vehicles, watercrafts including a variety of boats and ships, aircrafts, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The above and other features of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a graph showing a correlation between impact resistance and viscosity of a standard acrylonitrile butadiene styrene (ABS) specimen measured in the Example of the present invention.

FIG. 2 is a graph showing a correlation between the impact resistance and the size of rubber phase of a standard acrylonitrile butadiene styrene (ABS) material measured in the Example of the present invention.

FIG. 3 is a graph showing a correlation between the impact resistance and surface tension of a standard acrylonitrile butadiene styrene (ABS) material measured in the Example of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

The present invention provides a method for predicting the impact resistance of acrylonitrile butadiene styrene (ABS) materials (“the ABS material(s)”). In a preferred embodiment, the method includes calculating a correlation between impact resistance, viscosity, interfacial tension, and size of rubber phase by measuring the impact resistance, the viscosity, the interfacial tension, and the size of the rubber phase of a standard ABS material (“standard ABS material”); measuring the viscosity, the interfacial tension, and the size of the rubber phase of the ABS material; and predicting the impact resistance by substituting the measured viscosity, interfacial tension, and size of rubber phase of the ABS material into a correlation calculated from the standard ABS material.

It has been found that when the content of butadiene as a rubber phase in the ABS material is increased, the impact resistance is improved. However, as the rubber content continues to be increased, a level is reached at which the reverse occurs such that further increase in rubber content results in deterioration of the properties of the ABS material. Further, it was determined that as the interfacial tension value, which is a criterion of compatibility between the rubber phase and SAN matrix, is lowered, the affinity therebetween (i.e. between the rubber phase and SAN matrix) is increased. When separation of the two phases (i.e. rubber phase and matrix) is difficult, the interfacial tension value can be indirectly represented by the surface tension value. The interfacial tension value is a very important factor that determines compatibility. It is further expected that the surface properties will vary according to the rubber content even when using the indirect measurement of the surface tension. The collective behavior of these factors is defined as a viscosity value and especially is measured as a melt viscosity value. The melt viscosity can be calculated by

$$\frac{\sqrt{( {G}^{′2} + {G}^{″2} )}}{Angular velocity}$$

using the sum of a storage modulus (G′) and a loss modulus (G″). Thus, the viscosity value can represent the impact resistance as the degree of elasticity.

In accordance with the present invention, a method for calculating the size of rubber phase dispersed in an ABS material is not particularly limited. In an exemplary embodiment, the size of the rubber phase is measured using a transmission electron microscope (TEM). When a TEM is used, a staining process, for example wherein the butadiene rubber phase is bonded with the double bonds contained therein using osmium tetroxide (OₛO₄), can be performed to measure the size of the rubber phase according to the content thereof. In this case, the measured rubber phase is shown in black, while the matrix, which is not stained, is transparent. Thus, it is possible to measure the average size of the rubber phase through an image analysis program.

Further, according to the present invention, the method for calculating the surface tension is not particularly limited. In one exemplary embodiment, it is possible to measure the surface tension with a contact angle meter using solvents, for example two solvents. In particular, the surface tension may be measured using water or a similar material as a polar solvent and ethylene glycol or a similar material as a nonpolar solvent, and then using a harmonic mean equation. In this case, it is preferred that the specimen be prepared in the form of a film having a uniform roughness. If the two phases can be separated, it is possible to calculate the interfacial tension from the surface tension value of each phase.

Methods for calculating the melt viscosity in accordance with the present invention are also not particularly limited. In accordance with one preferred embodiment, it is possible to measure the melt viscosity by a frequency sweep test, for example, by using a rotational rheometer.

In accordance with a preferred embodiment of the present invention, the impact resistance, the viscosity, the surface tension, and the size of the rubber phase are first measured with respect to an ABS material, which is defined as a standard ABS material, before measuring the impact resistance of another ABC material to be targeted for prediction (“the ABS material”). Thereafter, the viscosity, the surface tension, and the size of the rubber phase of the corresponding ABS material (standard ABS material) are measured and compared with the previously measured values, thus predicting the impact resistance of the target ABS material (the ABS material).

According to the present invention, the impact resistance can further be predicted by measuring the viscosity, the surface tension, and the size of the rubber phase of the ABS material and substituting the measured values into the following Equation 1,

Impact resistance ∝η^{5.8}×d^{18.0}×γ^{-115.8} [Equation 1]

wherein η represents the viscosity, d represents the size of rubber phase, and γ represents the surface tension. It is noted that this method can be extensively applied to all grades of ABS materials. When the above Equation 1 is used, the various properties can be predicted by the results of analyzing the viscosity, the size of the rubber phase, and the surface tension. As such, Equation 1 can be widely used in the development of new materials and benchmarking.

According to the method for predicting the impact resistance in accordance with the present invention, it is preferred that the ABS material contain about 20 to 40 wt % butadiene to increase the reliability.

Next, the present invention will be described in more detail with reference to the following Example. However, the following Example is illustrative only, and the scope of the present invention is not limited thereto.

### EXAMPLE

### Mechanical Properties of 3 Types of Specimens Each Containing 20 w %, 30 w %, and 40 w % Butadiene

The rubber content is believed to be the most important factor for determining impact resistance, and thus the amounts of butadiene used in the Example were varied. In the Example, 20 w % butadiene, 30 w % butadiene, and 40 w % butadiene, respectively, were mixed and extruded into pellets using a twin screw extruder. Then, the pellets were pressed into specimens according to the ASTM standard method using a hot press. The properties of the prepared specimens were evaluated using an Izod impact tester. The size of the rubber phase of the specimens was also measured using a transmission electron microscope (TEM). The results are shown in the following Table 1.

After the properties and the size of the rubber phase were measured, the surface tension was measured using two solvents, in particular water and ethylene glycol, and then using the harmonic mean equation. The specimens were prepared in the form of thin films by a hot press to measure the contact angle, and the results were substituted into the harmonic mean equation to calculate the surface tension. The calculation results are also shown in the following Table 1.

The viscosity of the specimens was measured using a rotational rheometer at a temperature of about 200° C. and in a frequency range of about 100 rad/s. The measurement results are also shown in the following Table 1.

TABLE 1

| | Izod impact strength | Viscosity | Surface | Size of rubber |
|---|---|---|---|---|
| | (Kgf*cm/cm) | (Pa*s) | tension | phase (nm) |
| ABS-20 | 35.9 | 58.2 | 31.5 | 58.2 |
| ABS-30 | 88.6 | 70.3 | 30.7 | 70.3 |
| ABS-40 | 202.2 | 88.1 | 30.1 | 88.1 |

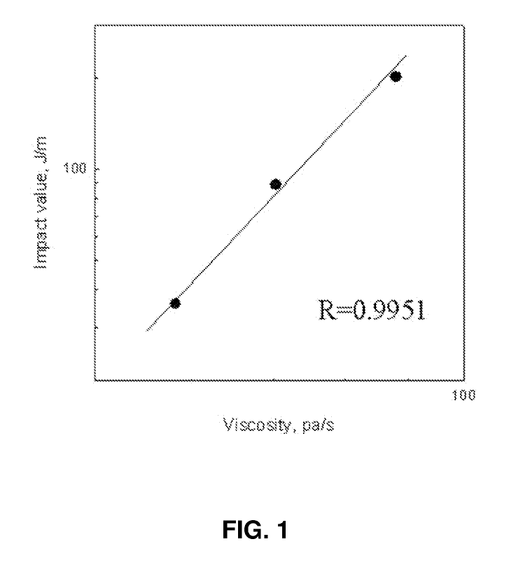

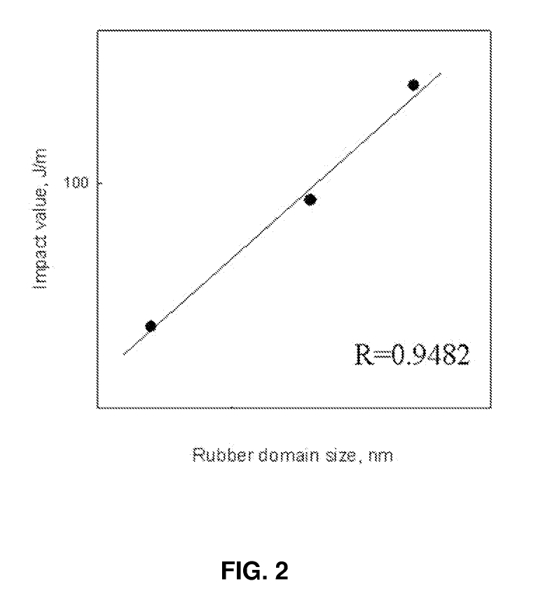

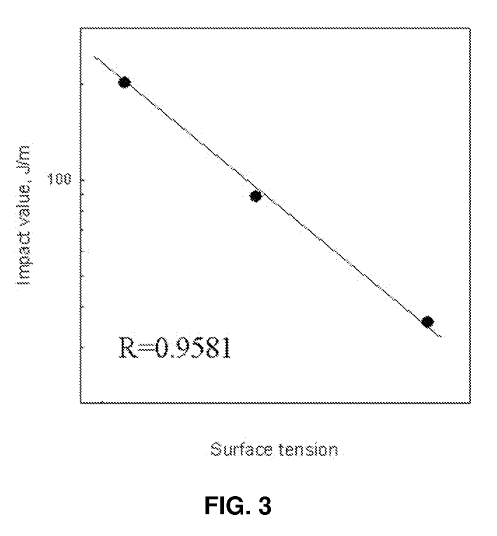

As shown in Table 1, it was confirmed that the impact strength had a relationship with the viscosity, the size of the rubber phase, and the surface tension. As shown in FIGS. 1 to 3, based on the correlation, a log-log plot of the correlation was obtained to develop a model equation for predicting properties. In particular, it could be seen that impact strength was increased as the viscosity was increased, as the size of the rubber phase was increased, and as the surface tension was reduced. Such a correlation can be represented by the following equation 1;

Impact resistance ∝η^{5.8}×d^{18.0}×γ^{-115.8} [Equation 1]

wherein η represents the viscosity, d represents the size of rubber phase, and γ represents the surface tension. This Equation 1 can be extensively applied to all grades of ABS materials. Further, when the above Equation 1 is used, the various properties can be predicted by the results of analyzing the viscosity, the size of the rubber phase, and the surface tension, and thus Equation 1 can be widely used in the development of new materials and benchmarking.

As described above, the present invention provides a model equation for predicting the impact resistance of ABS materials, and which provides high accuracy and reproducibility. ABS materials can, thus, be prepared which possess excellent properties, gloss, and stainability and, thus, can be widely used in vehicles, electricity and electronics, and miscellaneous applications. This prediction technology can, thus, be used particularly to determine whether a material complies with the specification of vehicle components, to overcome the quality problems, and to prevent the production of defective products.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A method for predicting the impact resistance of an acrylonitrile butadiene styrene (ABS) material, the method comprising:
calculating a correlation between impact resistance, viscosity, interfacial tension, and size of rubber phase by measuring the impact resistance, the viscosity, the interfacial tension, and the size of the rubber phase of a standard ABS material;
measuring the viscosity, the interfacial tension, and the size of the rubber phase of the ABS material; and
predicting the impact resistance by substituting the measured viscosity, interfacial tension, and size of rubber phase of the ABS material into the correlation calculated from the standard ABS material.

2. The method of claim 1, wherein the interfacial tension of the standard ABS material and/or the ABS material is a surface tension.

3. The method of claim 2, wherein the viscosity of the standard ABS material and/or the ABS material is a melt viscosity.

4. The method of claim 3, wherein the correlation is represented by the following Equation 1.
Impact resistance ∝η^{5.8}×d^{18.0}×γ^{11.58} [Equation 1]
wherein η represents the viscosity, d represents the size of rubber phase, and γ represents the surface tension.

5. The method of claim 1, wherein the ABS material comprises 20 to 40 wt % butadiene.

6. A method for predicting the impact resistance of an acrylonitrile butadiene styrene (ABS) material, the method comprising:
measuring the viscosity, the interfacial tension, and the size of the rubber phase of the ABS material; and
using the following Equation 1
Impact resistance ∝η^{5.8}×d^{18.0}×γ^{115.8} [Equation 1]
wherein η represents the viscosity, d represents the size of rubber phase, and γ represents the surface tension of the ABS material, to calculate the impact resistance.

7. The method of claim 6, wherein the interfacial tension is a surface tension.

8. The method of claim 6, wherein the viscosity is a melt viscosity.

9. The method of claim 6, wherein the ABS material comprises 20 to 40 wt % butadiene.
